(19) United States
(12) Patent Application Publication
(10) Pub. No.: US 2012/0326612 A1
(43) Pub. Date: Dec. 27, 2012

(54) INTELLIGENT LED

(76) Inventor: Martin KIRSTEN, Burscheid (DE)

(21) Appl. No.: 13/533,290

(22) Filed: Jun. 26, 2012

(30) Foreign Application Priority Data
Jun. 27, 2011 (DE) 20 2011 102479.6

(51) Int. Cl. H05B 37/02

(52) U.S. Cl. 315/153

(57) ABSTRACT

The invention relates to a light for illuminating a useable area, in particular a merchandise display area, comprising an adaptive illumination unit which has a number of coloured light-emitting diodes which emit light in the basic colours of a colour system, a sensor system directed towards the useable area which detects a light spectrum reflected by the useable area and/or objects lying on the useable area, and a control unit which is coupled to the sensor system and is designed to determine at least one dominant colour from the reflected light spectrum detected by the sensor system, and to actuate the light-emitting diodes to emphasise the at least one dominant colour such that they emit a light spectrum of a pre-specified colour temperature and/or intensity, in which the portion of the at least one dominant colour is increased.

### CROSS-REFERENCE TO RELATED APPLICATIONS AND CLAIM TO PRIORITY

This application is related to utility model 20 2011 102 479.6, filed Jun. 27, 2011 in the Federal Republic of Germany, the disclosure of which is incorporated herein by reference and to which priority is claimed.

### FIELD OF THE INVENTION

The present invention relates to a light for illuminating a useable area, in particular a merchandise display area, comprising an adaptive illumination unit which has a number of coloured light-emitting diodes which emit light in the basic colours of a colour system, a sensor system directed towards the useable area which detects a light spectrum reflected by the useable area and/or objects lying on the useable area, and a control unit which is coupled to the sensor system and is designed to determine at least one dominant colour from the reflected light spectrum detected by the sensor system, and to actuate the light-emitting diodes to emphasise the at least one dominant colour such that they emit a light spectrum of a pre-specified colour temperature and/or intensity, in which the portion of the at least one dominant colour is increased.

### BACKGROUND OF THE INVENTION

A light of this type is known from US 2008/0258590 A1. In this light, the colour of an object in a cube is detected by means of a camera. This picture is analyzed in order to determine the dominant colour of the object, and based on this analysis LEDs are actuated in such a way, that the inner faces of the cube shine in the dominant colour of the object.

A further light is known from DE 10 2007 004 843 A1. The previously known light comprises an adaptive illumination unit which can emit light in the basic colours of a pre-specified colour space or colour system and can be actuated individually by a control unit to radiate a desired light spectrum. Furthermore, a coloured light sensor is provided in order to detect a light spectrum of the ambient light so that varying ambient conditions can be taken into account for the actuation of the LEDs.

Furthermore, an optical detection unit is known from DE 10 2008 055 949 A1. This optical detection unit comprises a sensor system for generating a colour image of an object located in a detection area, and an adaptive illumination unit which has a number of coloured light sources that can control light in the basic colours of a colour system, and is provided in order to radiate light with a pre-specified colour temperature and/or intensity into the detection area of the sensor system. The actuation of the coloured light sources takes place here such that fluctuations in the colour temperature and/or intensity of the scattered light in the area surrounding the detection area can be compensated.

With the previously known LED lights changing light colours and white light colours the light mood can be affected. However, this only has a small effect upon the change of the colour saturation of product surfaces in order to achieve a sales-promoting effect of the illumination. Light colours and light colour changes are primarily visible on white surfaces and are perceived as the room climate, but they only affect product-related purchasing behaviour slightly or not at all.

In order to illuminate merchandise and display areas retrofit LED lights are therefore used which by a combination of coloured and white LEDs partially combined with luminescent materials generate special spectra for fresh food product groups such as for example meat and meat products, bakery products and fruit and vegetables (DE 20 2008 005 509 U1). In all of the solutions described for promoting sales of fresh food products these are static solutions for individual product groups.

### SUMMARY OF THE INVENTION

It is the object of the present invention to configure a light of the type specified at the start such that they can be used universally to illuminate merchandise display areas independently of the type of the products displayed on them.

According to the invention this object is achieved with a light of the type specified at least a white light spectrum is stored or can be stored in the control unit as a standard light spectrum with pre-specified colour temperature and/or intensity, the illumination unit has at least one white light light-emitting diode in order to emit light in the white spectral range, and the control unit actuates the white light light-emitting diode to emit the white light spectrum as the standard light spectrum, and additionally actuates the coloured light-emitting diodes to increase the portion of the at least one dominant colour, wherein the light-emitting diodes are actuated such that the modified light spectrum has a maximum intensity peak in the red spectral range at approximately 635 to 650 nm and a further minimum intensity peak in the green/yellow wavelength range at 490 to 560 nm, and finally an average intensity peak in the blue wavelength range at approximately 440 to 450 nm when red is the dominant colour and accordingly a white light spectrum with an increased red light portion is to be emitted, and/or wherein the light-emitting diodes are actuated such that the modified light spectrum has a maximum intensity peak in the red spectral range at approximately 635 to 650 nm, a further, average intensity peak in the green/yellow wavelength range at 495 to 566 nm, and finally a minimum intensity peak in the blue wavelength range at approximately 440 to 450 nm, when yellow is the dominant colour and accordingly a white light spectrum with an increased green/yellow light portion is to be emitted.

Therefore, in the light according to the invention there is stored or can be stored in the control unit a standard light spectrum with a pre-specified colour temperature and/or intensity with which a merchandise display area is to be illuminated, i.e. lit up. This standard light spectrum is a white light spectrum. By means of the sensor system the light spectrum which is reflected by the merchandise display area to be illuminated and the products located on the latter is detected and the dominant colour in the reflected light spectrum is determined. In order to emphasise the at least one dominant colour, the standard light spectrum is then modified in such a way that the portion of the at least one dominant colour in the standard light spectrum is increased and/or the portion of a complementary colour corresponding to the at least one dominant colour is reduced. In other words, a light spectrum is radiated that corresponds to a desired standard light spectrum, but in which the portion of the dominant colour is increased in order to emphasise the body colour of the products lying on the merchandise display area.

If, for example, meat products are positioned on the merchandise display surface, the colour red will be dominant in the reflected light spectrum. In this case the standard light spectrum is modified by increasing the red light portion. Since it is relatively frequently necessary to illuminate meat products, provision is made according to one embodiment of the invention such that a white light spectrum with an increased red light portion is stored or can be stored in the control unit as a modified standard light spectrum, and the control unit actuates the illumination unit to emit this light spectrum if red is the dominant colour in the reflected light spectrum detected by the sensor system. If therefore an increased red light portion is detected in the reflected light spectrum, this already pre-selected light spectrum is automatically selected and emitted.

Alternatively and/or in addition, a white light spectrum with an increased green/yellow light portion is stored or can be stored in the control unit, the control unit then actuating the exposure unit to emit this light spectrum if yellow is the dominant colour of the reflected light spectrum detected by the sensor system. This is the case, for example, if bakery products are being illuminated.

According to the present invention the illumination unit has at least one white light light-emitting diode in order to emit light in the white spectral range, and a white light spectrum is stored as the standard light spectrum in the control unit. The control unit then actuates the white light light-emitting diode to emit the white light spectrum as the standard light spectrum, and additionally actuates the coloured light-emitting diodes to increase the portion of the at least one dominant colour. In other words, the white light spectrum which the white light-emitting diode emits is overlapped by a light spectrum which is generated by the coloured light-emitting diodes. If, for example, the colour red is to be emphasised, the control unit will actuate the white light light-emitting diode to emit the white light spectrum as the standard light spectrum. In addition, the red, green and blue LEDs of the so-called RBG colour space are actuated such that the modified light spectrum, which is produced by the overlapping of the light spectra emitted by the coloured light-emitting diodes and the white light light-emitting diode, is a white light spectrum with an increased red light portion. The light-emitting diodes are actuated such that the modified light spectrum has a maximum intensity peak in the red spectral range at approximately 635 to 650 nm, a further, minimum intensity peak in the green/yellow wavelength range at 495 to 566 nm, and finally an average intensity peak in the blue wavelength range at approximately 440 to 450 nm. In particular, the light-emitting diodes are actuated such that, assuming that the maximum standardised intensity in the red spectral range is 100%, the intensity peak in the green/yellow wavelength range is at 15 to 20% and in particular 17%, and the intensity peak in the blue wavelength range is at approximately 20 to 25%, in particular at approximately 22%.

If bakery products are being illuminated, and so the green/yellow wavelength range is to be emphasised, the control unit will actuate the white light light-emitting diodes and the coloured LEDs such that a white light spectrum with an increased green/yellow light portion is emitted. In this case the light-emitting diodes are advantageously actuated such that the modified light spectrum has a maximum intensity peak in the red spectral range at approximately 635 to 650 nm, a further, average intensity peak in the green/yellow wavelength range at 495 to 566 nm, and finally a minimum intensity peak in the blue wavelength range at approximately 440 to 450 nm. In particular, the light-emitting diodes are actuated such that the light-emitting diodes are actuated such that, assuming that the maximum standardised intensity in the red spectral range is 100%, the intensity peak in the green/yellow wavelength range is at 35 to 45% and in particular 40%, and the intensity peak in the blue wavelength range is at approximately 20 to 25%, in particular at approximately 22%.

In a further configuration of the present invention provision is made such that the control unit has a detection mode in which the illumination unit and the sensor system are controlled such that the illumination unit emits a detection light spectrum and the sensor system detects the light spectrum reflected by the useable area and/or objects lying on the useable area in order to determine the dominant colour in the reflected light spectrum. In other words, in order to determine the dominant colour a detection mode in which the illumination unit emits a detection light spectrum is selected. This detection light spectrum can be the stored standard light spectrum. The detection mode is preferably selected automatically at pre-specified times, in particular after switching on the light and/or at pre-specified intervals of time during operation. Manual activation may also be possible.

According to one embodiment of the present invention the illumination unit has a light mixing chamber with a light outlet opening in which the light-emitting diodes are arranged, the light mixing chamber being designed to mix the light emitted by light-emitting diodes before it passes out of the mixing chamber. For this purpose the internal surfaces of the light mixing chamber can be designed to be dispersively reflective. Advantageously the internal surfaces of the light mixing chamber are provided with a reflection-enhancing coating, in particular a thin silver layer with a reflection-enhancing interference layer. By providing this type of light mixing chamber, homogeneous mixing of the light irradiated by the light-emitting diodes is achieved. In addition, a diffusion disc can be provided on the light outlet opening of the mixing chamber.

In the configuration of this embodiment provision can be made such that there is provided in the light mixing chamber a further sensor system connected to the control unit which detects the light spectrum of the light emitted by the light-emitting diodes and mixed in the light mixing chamber, the control unit carrying out a permanent or recurring target/actual comparison of the light spectrum detected in the light mixing chamber with the modified standard light spectrum to be emitted, and controlling the light-emitting diodes such that the light spectrum of the light mixed in the light mixing chamber corresponds to the pre-specified modified standard light spectrum. By permanently checking it is guaranteed that the respectively generated modified overall light spectrum is not changed by heating and ageing of the light-emitting diodes.

In a known way a reflector, which in particular generates a symmetrical photographic image in two planes perpendicular to one another, and which in particular surrounds the light outlet opening of the light mixing chamber, can be provided. This reflector advantageously has at least four reflector segments, in particular two opposite pairs of side wall reflectors and face wall reflectors, which define a light outlet opening on the lower side. The reflector segments can lie next to one another in the circumferential direction and be connected or connectable to one another. For this purpose it is possible to provide connection elements on the upper and lower end regions of the reflector segments which can be engaged with one another, and to connect the reflector segments to one another detachably. The reflector can also have a reflection-enhancing coating on the inside, in particular a vapour-coated layer of a rust-proof material.

### BRIEF DESCRIPTION OF THE FIGURES

With regard to further embodiments of the invention, reference is made to the sub-claims and to the following description of an exemplary embodiment with reference to the attached drawings. The drawings show as follows:

FIG. 1 a diagrammatic illustration of a light for illuminating a merchandise display area according to the present invention;

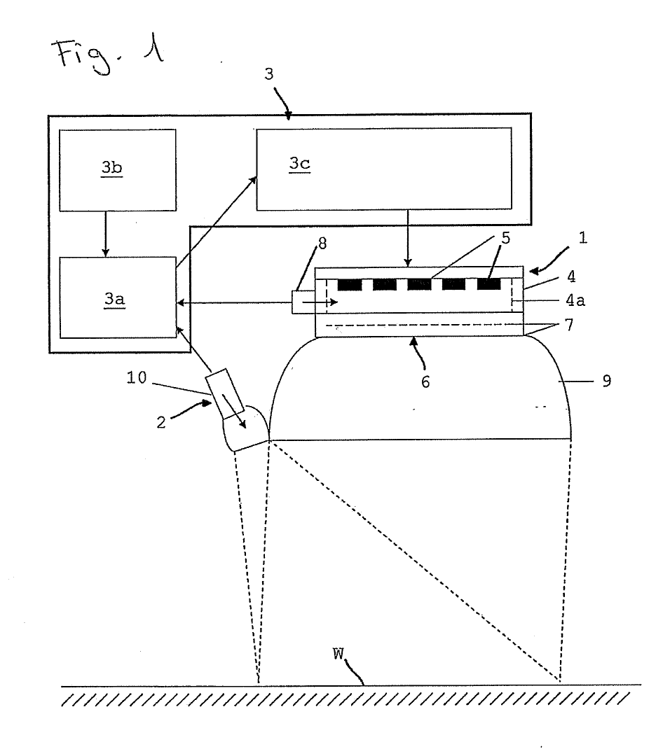

FIG. 2 a white light spectrum, and

FIG. 3 a white light spectrum as the standard light spectrum and two modified standard light spectra for emphasising a red and a yellow colour.

### DETAILED DESCRIPTION OF THE PREFERRED EMBODIMENT(S)

The light comprises an illumination unit 1, which is directed towards the useable area W to be illuminated—in this instance a merchandise display area—, a sensor system 2 directed towards the useable area W and which detects a light spectrum reflected by the useable area W and/or objects lying on the useable area W, and a control unit 3 with a controller board 3a, a microprocessor 3b and a power supply 3c to which the illumination unit 1 and the sensor system 2 are connected. The control unit 3 is designed to actuate the illumination unit 1 taking into account the reflected light spectrum detected by the sensor system.

The illumination unit 1 comprises a light mixing chamber 4 in which five LED modules 5 with a number of light-emitting diodes emitting light in the basic colours red, green and blue of an RGB colour space are provided. In addition to the differently coloured light-emitting diodes each LED module 5 has a white light light-emitting diode. There is provided on the lower side of the light mixing chamber a light outlet opening 6 in which a diffusion disc 7 is fitted. The internal surfaces of the light mixing chamber 4 are provided with a silver layer with a reflection-enhancing interference layer. Furthermore, there is accommodated within the light mixing chamber 4 a sensor system 8 connected to the control unit 3 which detects the light spectrum of the light emitted by the LED modules 5 and mixed in the light mixing chamber 4.

A reflector 9 is positioned beneath the light mixing chamber 4 and surrounding the light outlet opening 6. The reflector 9 is formed by two pairs of side wall reflectors lying opposite one another and face wall reflectors which on their lower side define a light outlet opening. The side wall reflectors and the face wall reflectors are formed by discrete reflector segments which lie next to one another in the circumferential direction and are connected to one another at their upper and lower end region. For this purpose connection elements in the form of hooks (not shown) which are engaged with one another are provided on the reflector segments. The reflector segments are produced from aluminium sheet, and the internal surfaces have a vapour-coated layer of a rust-proof metal in order to enhance reflection.

The sensor system 2 directed towards the illuminated useable area W has a colour sensor 10 for detecting the light spectrum reflected by the useable area W and the objects lying on the latter.

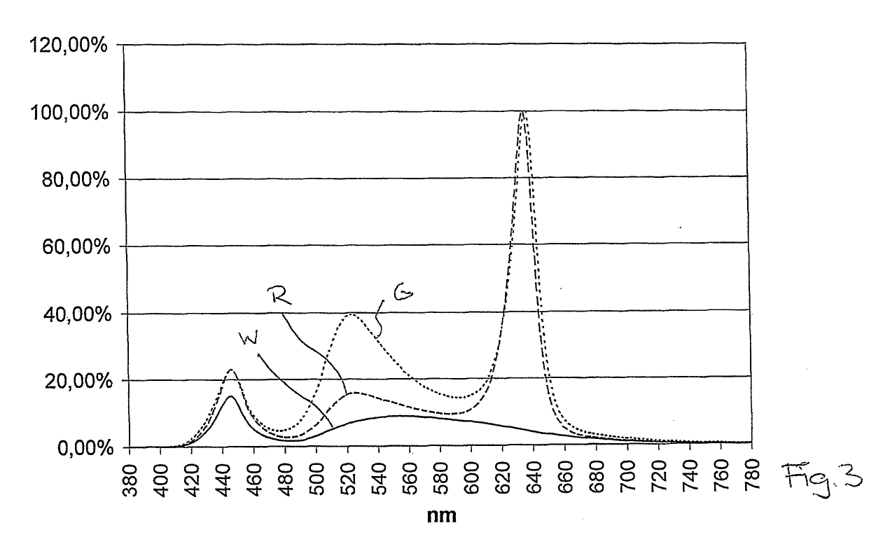

At least one standard light spectrum of a pre-specified colour temperature and/or intensity is stored in the control unit 3. In the embodiment shown this standard light spectrum is a white light spectrum W which is shown as a continuous line in FIG. 3. The control unit 3 is designed to determine a dominant colour in a light spectrum detected by the sensor system 2, i.e. reflected by the useable area W, and to actuate the light-emitting diodes of the LED modules 5 such that the at least one dominant colour is emphasised. For this purpose the stored standard light spectrum is modified such that the portion of the dominant colour is increased and/or the portion of the colour complementary to the at least one dominant colour is reduced. The LED modules 5 are actuated in a known way by the supply of power to the individual light-emitting diodes in the power supply 3c being changed. Here the white light light-emitting diodes emit the white light spectrum B as a standard spectrum which is overlapped and so modified by the light spectra which are emitted by the coloured light-emitting diodes.

In the exemplary embodiment shown two modified standard light spectra are already placed in the control unit 3, namely a first modified standard light spectrum R, in which the white light spectrum is stored as a standard light spectrum with an increased red light portion, and the yellow light portion G is increased in the second modified standard light spectrum.

As can be seen in FIG. 3, in the first modified standard light spectrum, which is shown by a dashed line R, in addition to the orange/red spectral range (600 to approximately 600 nm wavelength), the blue spectral range (434 to 495 nm wavelength) and the green/yellow wavelength range (495 to 566 nm) are also increased. In the second modified standard light spectrum, that is shown by a dotted line G in FIG. 3, the red and the blue spectral ranges are increased just as greatly in the first modified standard light spectrum R, and in addition the green/yellow spectral range is also increased more greatly than in the first modified standard light spectrum R.

In both modified standard light spectra the maximum intensity comes in the red spectral range, and so is specified, standardised in FIG. 3, as 100%. In contrast, in the first modified standard light spectrum R the intensity peak in the green/yellow wavelength range is approximately 17% and the intensity peak in the blue wavelength range is approximately 22%. In contrast, in the second modified standard light spectrum the intensity peak is more pronounced with 40%.

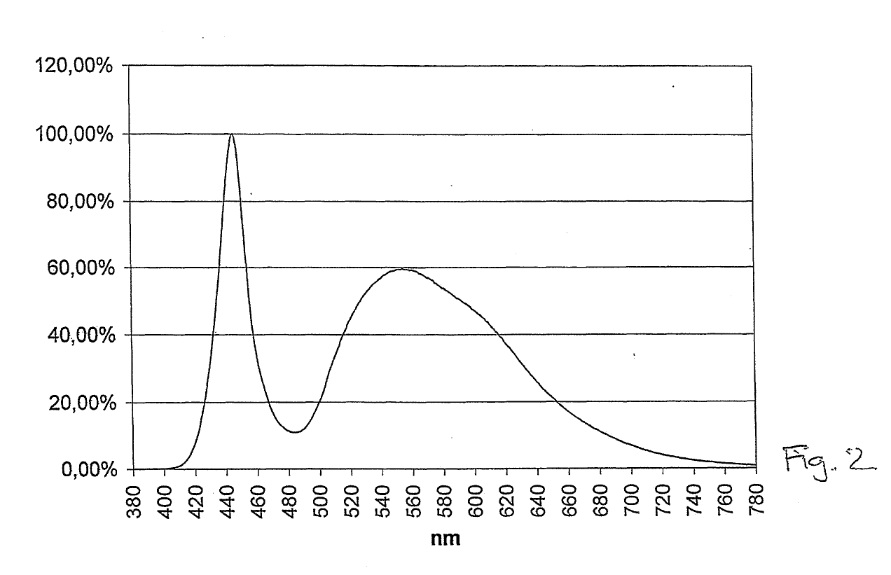

The control unit 3 can be switched into a detection mode in which the illumination unit 1 and the sensor system 2 are actuated such that the illumination unit 1 emits a pre-specified detection light spectrum. This is the white light spectrum stored as the standard light spectrum that is, however, radiated with a maximum intensity, as shown in FIG. 2. The sensor system 2 detects the light spectrum reflected by the useful surface W and/or the products lying on the useful surface W in order to determine the dominant colour in the reflected light spectrum. The detection mode is activated automatically when the light is brought into operation.

During operation a merchandise display area W with the meat and butchery products lying over this area is to be illuminated with the light described above. When the light is switched on the control unit 3 switches into the detection mode in which the illumination unit 1 radiates the white light spectrum stored as the standard light spectrum with full intensity (FIG. 2). The sensor system 2 detects the light spectrum reflected by the meat and butchery products and which is evaluated in the control unit 3 in order to determine the dominant colour in the reflected light spectrum. With the meat and butchery products to be illuminated this is the colour red. Accordingly, the control unit 3 actuates the illumination unit 1 to emit the first modified standard light spectrum, i.e. the white light spectrum, placed in the control unit 3 with an increased red light portion according to the dashed line R in FIG. 3.

The light radiated by the light-emitting diodes of the LED modules 5 is mixed in the light mixing chamber 4 before it is radiated into the reflector 9 by the diffusion disc 7. The sensor system 8 provided in the light mixing chamber 4 detects the light spectrum of the light mixed in the light mixing chamber 4. The detected light spectrum is forwarded digitally to the control unit 3 which carries out a permanent target/actual comparison of the detected light spectrum with the first modified light spectrum to be emitted. If there are deviations due to ageing or heat, the control unit 3 makes corresponding adaptations in the actuation of the LED modules 3 until there are no more deviations or the deviations come within a pre-specified tolerance range.

The present invention has been described herein in terms of one or more preferred embodiments. However, it should be understood that numerous modifications and variations to these embodiments would be apparent to those skilled in the art upon a reading of the foregoing description. Therefore, it is intended that any such modifications and variations comprise a part of this invention, provided they come within the scope of the following claims and their equivalents.

I claim:

1. A light for illuminating a useable area, in particular a merchandise display area (W), comprising an adaptive illumination unit (1) which has a number of coloured light-emitting diodes which emit light in the basic colours of a colour system, a sensor system (2) directed towards the useable area (W) which detects a light spectrum reflected by the useable area (W) and/or objects lying on the useable area, and a control unit (3) which is coupled to the sensor system (2) and is designed to determine at least one dominant colour from the reflected light spectrum detected by the sensor system (2), and to actuate the light-emitting diodes to emphasise the at least one dominant colour such that they emit a light spectrum of a pre-specified colour temperature and/or intensity, in which the portion of the at least one dominant colour is increased, characterised in that at least a white light spectrum is stored or can be stored in the control unit (3) as a standard light spectrum with pre-specified colour temperature and/or intensity, the illumination unit (1) has at least one white light light-emitting diode in order to emit light in the white spectral range, and the control unit (3) actuates the white light light-emitting diode to emit the white light spectrum as the standard light spectrum, and additionally actuates the coloured light-emitting diodes to increase the portion of the at least one dominant colour, wherein the light-emitting diodes are actuated such that the modified light spectrum has a maximum intensity peak in the red spectral range at approximately 635 to 650 nm and a further minimum intensity peak in the green/yellow wavelength range at 490 to 560 nm, and finally an average intensity peak in the blue wavelength range at approximately 440 to 450 nm when red is the dominant colour and accordingly a white light spectrum with an increased red light portion is to be emitted, and/or wherein the light-emitting diodes are actuated such that the modified light spectrum has a maximum intensity peak in the red spectral range at approximately 635 to 650 nm, a further, average intensity peak in the green/yellow wavelength range at 495 to 566 nm, and finally a minimum intensity peak in the blue wavelength range at approximately 440 to 450 nm, when yellow is the dominant colour and accordingly a white light spectrum with an increased green/yellow light portion is to be emitted.

2. The light according to claim 1, characterised in that the light-emitting diodes are actuated such that, assuming that the maximum standardised intensity in the red spectral range is 100%, the intensity peak in the green/yellow wavelength range is at 15 to 20% and in particular 17%, and the intensity peak in the blue wavelength range is at approximately 20 to 25%, in particular at approximately 22%, when a white light spectrum with an increased red light portion is to be emitted, and/or wherein the light-emitting diodes are actuated such that, assuming that the maximum standardised intensity in the red spectral range is 100%, the intensity peak in the green/yellow wavelength range is at 35 to 45% and in particular 40%, and the intensity peak in the blue wavelength range is at approximately 20 to 25%, in particular at approximately 22%, when a white light spectrum with an increased green/yellow light portion is to be emitted.

3. The light according to claim 1, characterised in that the control unit (3) actuates the white light light-emitting diode to emit the white light spectrum as the standard light spectrum, and additionally actuates red, green and blue LEDs such that the modified light spectrum, which is produced by overlapping the light spectra emitted by the coloured light-emitting diodes and the white light light-emitting diode, is a white light spectrum with the increased red or green/yellow light portion.

4. The light according to claim 2, characterised in that the control unit (3) actuates the white light light-emitting diode to emit the white light spectrum as the standard light spectrum, and additionally actuates red, green and blue LEDs such that the modified light spectrum, which is produced by overlapping the light spectra emitted by the coloured light-emitting diodes and the white light light-emitting diode, is a white light spectrum with the increased red or green/yellow light portion.

5. The light according to claim 1, characterised in that a white light spectrum with an increased red light portion is stored or can be stored in the control unit (3) as a modified standard light spectrum, and the control unit (3) actuates the illumination unit (1) to emit this light spectrum if red is the dominant colour in the reflected light spectrum detected by the sensor system (2) and/or that a white light spectrum is stored or can be stored with an increased green/yellow light portion in the control unit (3) as a modified standard light spectrum, and the control unit (3) actuates the illumination unit (1) to emit this light spectrum if yellow is the dominant colour in the reflected light spectrum detected by the sensor system (2).

6. The light according to claim 2, characterised in that a white light spectrum with an increased red light portion is stored or can be stored in the control unit (3) as a modified standard light spectrum, and the control unit (3) actuates the illumination unit (1) to emit this light spectrum if red is the dominant colour in the reflected light spectrum detected by the sensor system (2) and/or that a white light spectrum is stored or can be stored with an increased green/yellow light portion in the control unit (3) as a modified standard light spectrum, and the control unit (3) actuates the illumination unit (1) to emit this light spectrum if yellow is the dominant colour in the reflected light spectrum detected by the sensor system (2).

7. The light according to claim 1, characterised in that the control unit (3) has a detection mode in which the illumination unit (1) and the sensor system (2) are controlled such that the illumination unit (1) emits a detection light spectrum and the sensor system (2) detects the light spectrum reflected by the useable area (W) and/or objects lying on the useable area (W) in order to determine the dominant colour in the reflected light spectrum, wherein preferably the control unit (3) is designed to select the detection mode automatically, at pre-specified times, in particular after switching on the light and/or during operation at pre-specified intervals of time and/or manually.

8. The light according to claim 2, characterised in that the control unit (3) has a detection mode in which the illumination unit (1) and the sensor system (2) are controlled such that the illumination unit (1) emits a detection light spectrum and the sensor system (2) detects the light spectrum reflected by the useable area (W) and/or objects lying on the useable area (W) in order to determine the dominant colour in the reflected light spectrum, wherein preferably the control unit (3) is designed to select the detection mode automatically, at pre-specified times, in particular after switching on the light and/or during operation at pre-specified intervals of time and/or manually.

9. The light according to claim 1, characterised in that the illumination unit (1) has a light mixing chamber (4) with a light outlet opening (6) in which the light-emitting diodes are arranged, and that the light mixing chamber (4) is designed to mix the light emitted by the light-emitting diodes before it passes out of the light mixing chamber (4), wherein preferably the internal surfaces of the light mixing chamber (4) are designed to be dispersively reflective and/or internal surfaces of the light mixing chamber (4) are provided with a reflection-enhancing coating, in particular a thin silver layer with a reflection-enhancing interference layer.

10. The light according to claim 9, characterised in that a diffusion disc (7) is provided on the light outlet opening (6) of the light mixing chamber (4).

11. The light according to claim 9, characterised in that there is provided in the light mixing chamber (4) a further sensor system (2) connected to the control unit (3) which detects the light spectrum of the light emitted by the light-emitting diodes and mixed in the light mixing chamber (4), the control unit (3) carrying out a permanent or recurring target/actual comparison of the light spectrum detected in the light mixing chamber (4) with the modified standard light spectrum to be emitted, and controlling the light-emitting diodes such that the light spectrum of the light mixed in the light mixing chamber corresponds to the pre-specified modified standard light spectrum.

12. The light according to claim 2, characterised in that the illumination unit (1) has a light mixing chamber (4) with a light outlet opening (6) in which the light-emitting diodes are arranged, and that the light mixing chamber (4) is designed to mix the light emitted by the light-emitting diodes before it passes out of the light mixing chamber (4), wherein preferably the internal surfaces of the light mixing chamber (4) are designed to be dispersively reflective and/or internal surfaces of the light mixing chamber (4) are provided with a reflection-enhancing coating, in particular a thin silver layer with a reflection-enhancing interference layer.

13. The light according to claim 12, characterised in that a diffusion disc (7) is provided on the light outlet opening (6) of the light mixing chamber (4).

14. The light according to claim 12, characterised in that there is provided in the light mixing chamber (4) a further sensor system (2) connected to the control unit (3) which detects the light spectrum of the light emitted by the light-emitting diodes and mixed in the light mixing chamber (4), the control unit (3) carrying out a permanent or recurring target/actual comparison of the light spectrum detected in the light mixing chamber (4) with the modified standard light spectrum to be emitted, and controlling the light-emitting diodes such that the light spectrum of the light mixed in the light mixing chamber corresponds to the pre-specified modified standard light spectrum.
